(19) United States
(12) Patent Application Publication
(10) Pub. No.: US 2014/0104128 A1
(43) Pub. Date: Apr. 17, 2014

(54) ANTENNA STRUCTURE WITH RECONFIGURABLE PATTERNS

(71) Applicant: INDUSTRIAL TECHNOLOGY RESEARCH INSTITUTE, Hsinchu (TW)

(72) Inventors: TA CHUN PU, KAOHSIUNG CITY (TW); JUI HUNG CHEN, TAICHUNG CITY (TW); HUNG HSUAN LIN, HSINCHU COUNTY (TW); CHUN YIH WU, TAIPEI CITY (TW)

(73) Assignee: INDUSTRIAL TECHNOLOGY RESEARCH INSTITUTE, Hsinchu (TW)

(21) Appl. No.: 14/024,988

(22) Filed: Sep. 12, 2013

(30) Foreign Application Priority Data
Oct. 12, 2012 (TW) 101137615

(51) Int. Cl. H01Q 3/24

(52) U.S. Cl. CPC H01Q 3/247
USPC 343/848; 343/876

(57) ABSTRACT

An antenna structure with reconfigurable patterns includes a grounded plane, at least one active antenna, and at least one current dragger. The active antenna is disposed adjacent to a side of the grounded plane, while the current dragger is disposed adjacent to another side of the grounded plane. The current dragger includes at least one switch. The at least one switch is configured to selectively conduct a current at the grounded plane to the current dragger or electrically insulate a current at the grounded plane from the current dragger.

The present application claims priority from Taiwanese application Ser. No. 101137615, filed on Oct. 12, 2012, of the same title and inventorship herewith.

### 1. TECHNICAL FIELD

The present disclosure relates to an antenna structure with reconfigurable patterns.

### 2. RELATED ARTS

Smart antennas play an important role in antenna design for wireless communication systems, and may mainly be classified into two categories: multiple input multiple output (MIMO) antenna technology and adaptive antenna system (AAS).

MIMO antenna technology uses multiple wireless transmission paths to increase signal coverage or data throughput. AAS technology uses multiple antennas to form an antenna array, dynamically adjusts the input power for each antenna unit for beam steering towards target devices for data transmission, and achieves high efficient transmission by increasing signal to noise ratio (SNR) and reducing co-channel interference. Moreover, if a mobile object, such as a human being or an obstacle, blocks the signal transmission path and causes interference, the system will readjust the beam steering in real time to form a new transmission path and continue transmission. Although the antenna array has a relatively high configuration precision in directivity (or the narrow main beam beamwidth), in general, such antenna array includes complicated components, occupies a lot of space, and is expensive.

The configuration of antenna radiation pattern may be realized in many ways by, for example, forming an array antenna (multiple antennas), changing electromagnetic coupling, changing radio frequency (RF) current distribution, and others. The array antenna approach is to control the excited phase and amplitude of each antenna so as to realize a specific radiation pattern. The changing electromagnetic coupling approach, by way of a Yagi antenna for example, configures a passive antenna to a wave-guided or reflective structure to change beam direction.

FIGS. 1-3 show three similar antenna structures with corresponding radiation patterns. As shown in FIGS. 1-3, the antenna in three antenna structures 31-33 with different RF currents will generate different radiation patterns 31a, 32a, 33a. In FIG. 1, a balanced antenna structure 31 has a symmetrical structure so that the RF current exhibits a symmetrical distribution. As such, the radiation pattern 31a is also symmetrical. In FIG. 2, an unbalanced antenna structure 32 incorporates a system grounded plane 32b as a part of an antenna radiation metal. Because the structure 32 is asymmetrical, the asymmetrical RF current distribution makes the beam direction leaning towards the system grounded plane 32b.

As the relative position between the unbalanced antenna structure and the system grounded plane is different, the RF current distribution will be different and, as shown in FIGS. 2-3, radiation patterns 32a, 33a and optimal signal reception direction will also be different.

The changing RF current approach to realize an antenna radiation pattern, for example, the antenna device changes its beam direction through switching the connection status between a grounded conductor and auxiliary ground conductors.

### SUMMARY

According to one embodiment, an antenna structure with reconfigurable radiation patterns is provided. The antenna structure includes a grounded plane, at least one active antenna, and a radio frequency (RF) current dragger.

The grounded plane a grounded plane includes a first edge and a second edge, wherein the first edge and the second edge form an angle with respect to one another. The at least one active antenna is disposed adjacent to the first edge and electrically coupled to an RF signal source. The RF current dragger is disposed adjacent to the second edge.

The RF current dragger includes at least one switch component, wherein the at least one switch component is configured to adjust a resonance frequency of the at least one RF current dragger so as to either guide in or cut off an RF current at the grounded plane to or from the RF current dragger.

According to another embodiment, the present disclosure also provides an antenna structure with a reconfigurable radiation pattern including a grounded plane, a first radiation area, a second radiation area, a first control line and a second control line.

The grounded plane includes a first area and a second area, wherein the first area is adjacent to the second area. The first area includes a first edge and a second edge. The first edge and the second edge form an angle with respect to one another.

A first radiation area is disposed adjacent to the first area and includes a first active antenna and a first RF current dragger.

The first active antenna is disposed adjacent to the first edge and electrically coupled to a RF signal source. The first RF current dragger is disposed adjacent to the second edge and includes a first switch component.

The second radiation area is disposed adjacent to the second area and includes a second active antenna and a second RF current dragger, wherein the second RF current dragger includes a second switch component.

The first control line is electrically connected to the first RF current dragger. In addition, the second control line is electrically connected to the second RF current dragger.

The first control line and the second control line are configured to output a control signal to the first switch component and the second switch component. The first switch component adjusts the resonant frequency of the first RF current dragger in response to the control signal. The RF current at the grounded plane is either guided into or cut off from the first RF current dragger in response to the resonant frequency of the first RF current dragger. The second switch component adjusts the resonant frequency of the second RF current dragger in response to the control signal. The RF current at the grounded plane is either guided into or cut off from the second RF current dragger in response to the resonant frequency of the second RF current dragger.

According to another embodiment, the present disclosure further provides an antenna structure with reconfigurable radiation patterns. Such antenna structure includes a grounded plane, at least one active antenna, and at least one RF current dragger.

The grounded plane includes a first edge and a second edge, wherein the first edge and the second edge form an angle with respect to one another. The active antenna is disposed adjacent to the first edge and electrically coupled to a RF signal source.

The RF current dragger is disposed adjacent to the second edge and includes at least one switch component. The at least one switch component is disposed between the grounded plane and the at least one RF current dragger and configured to either guide in or cut off the RF current at the grounded plane to or from the at least one RF current dragger.

According to another embodiment, the present disclosure also provides an antenna structure with reconfigurable radiation patterns. Such antenna structure includes a grounded plane, a first radiation area, a second radiation area, a first control line, and a second control line.

The grounded plane includes a first area and a second area, wherein the first area is adjacent to the second area. The first area includes a first edge and a second edge. The first edge and the second edge form an angle with respect to one another.

The first radiation area is disposed adjacent to the first area and includes a first active antenna and a first RF current dragger.

The first active antenna is disposed adjacent to the first edge and electrically coupled to a RF signal source. The first RF current dragger is disposed adjacent to the second edge and includes a first switch component. The first switch component is configured to electrically couple to the first RF current dragger or the grounded plane.

The second radiation area is disposed adjacent to the second area and includes a second active antenna and a second RF current dragger. The second RF current dragger includes a second switch component.

The first control line is electrically connected to the first RF current dragger. The second control line is electrically connected to the second RF current dragger.

The first control line and the second control line are configured to output a control signal to the first switch component and the second switch component. The first switch component is disposed between the grounded plane and the first RF current dragger. The second switch component is disposed between grounded plane and the second RF current dragger. The first switch component switches between open-circuit status and short-circuit status between the first RF current dragger and the grounded plane in response to the control signal. During the short-circuit status, the first switch component guides the RF current at the grounded plane into the first RF current dragger. During the open-circuit status, the first switch component cuts off the RF current at the grounded plane from the first RF current dragger. The second switch component switches between open-circuit status and short-circuit status between the second RF current dragger and the grounded plane in response to the control signal. During the short-circuit status, the second switch component guides the RF current at the grounded plane into the second RF current dragger. During the open-circuit status, the second switch component cuts off the RF current at the grounded plane from the second RF current dragger.

Another function of the present disclosure will be described at following paragraphs. Certain functions can be realized in present section, while the other functions can be realized in detailed description. In addition, the indicated components and the assembly can be explained and achieved by detail of the present disclosure. Notably, the previous explanation and the following description are demonstrated instead of limiting the scope of the present disclosure.

The foregoing has outlined rather broadly the features and technical benefits of the disclosure in order that the detailed description of the disclosure that follows may be better understood. Additional features and benefits of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes of the disclosure. It should also be realized by those skilled in the art that such equivalent constructions do not depart from the spirit and scope of the disclosure as set forth in the appended claims.

### BRIEF DESCRIPTION OF THE DRAWINGS

The accompanying drawings, which are incorporated in and constitute a part of this specification, illustrate embodiments of the disclosure and, together with the description, serve to explain the principles of the invention.

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

A more complete understanding of the present disclosure may be derived by referring to the detailed description and claims when considered in connection with the Figures, where like reference numbers refer to similar elements throughout the Figures, and:

FIGS. 1-3 show three similar types of antenna structures and corresponding radiation patterns;

FIG. 4 is a schematic view illustrating the active antenna and RF current dragger of the antenna structure in accordance with an embodiment of the present disclosure;

FIGS. 5-7 show exemplary schematic views of three embodiments of pseudo antenna type current dragger, consistent with certain disclosed embodiments;

FIG. 8 shows a schematic view of an exemplary monopole type RF current dragger, consistent with certain disclosed embodiments;

FIG. 9 is a schematic view showing how the RF current at ground plane is guided into the RF current dragger in accordance with another embodiment of the present disclosure;

FIG. 10 is schematic view illustrating the antenna radiation pattern corresponding to the grounded plane current distribution of antenna structure of FIG. 9 in the cut-off mode, consistent with certain disclosed embodiments;

FIG. 11 is schematic view showing the antenna radiation pattern corresponding to the grounded plane current distribution of antenna structure of FIG. 9 in a guide-in mode, consistent with certain disclosed embodiments;

FIG. 12 is a schematic view illustrating an antenna structure with an inductor and a slot in accordance with another embodiment of the present disclosure;

FIG. 13 is an enlarged view of the embodiment from FIG. 12 illustrating antenna structure with an inductor and a slot in accordance with another embodiment of the present disclosure;

FIG. 14 is a schematic view showing the RF current dragger of the antenna structure in accordance with alternative embodiment of the present disclosure;

FIG. 15 is a schematic view showing the antenna radiation pattern corresponding to the slot of the antenna structure which is adjacent to the second edge of the grounded plane, consistent with certain disclosed embodiments;

FIG. 16 is a schematic view illustrating the antenna radiation pattern corresponding to the slot of the antenna structure which is away from the second edge of the grounded plane, consistent with certain disclosed embodiments;

FIG. 17 is a schematic view illustrating another antenna structure with multiple slots in accordance with another embodiment in the present disclosure;

FIGS. 18-20 illustrates the antenna radiation patterns corresponding to the number of the slot located in the antenna structure, consistent with certain disclosed embodiments;

FIG. 21 illustrates a schematic view of another antenna structure with the slot in accordance with the cut-off embodiment of the present disclosure;

FIG. 22 is schematic view illustrating the antenna radiation pattern corresponding to the grounded plane current distribution of the antenna structure with the slot of FIG. 21, consistent with certain disclosed embodiments;

FIG. 23 illustrates a schematic view of another antenna structure with the slot of FIG. 21 in accordance with the guide-in embodiment of the present disclosure;

FIG. 24 is schematic view showing the antenna radiation pattern corresponding to the grounded plane current distribution of the antenna structure with the slot of FIG. 23, consistent with certain disclosed embodiments;

FIG. 25 illustrates a schematic view of another antenna structure with the two slots in accordance with the embodiment of the present disclosure;

FIG. 26 is schematic view showing the antenna radiation pattern corresponding to the grounded plane current distribution of antenna structure of FIG. 25 in the cut-off mode, consistent with certain disclosed embodiments;

FIG. 27 illustrates a schematic view of another antenna structure with the two slots in accordance with FIG. 25 embodiment of the present disclosure;

FIG. 28 is schematic view showing the antenna radiation pattern corresponding to the grounded plane current distribution of antenna structure of FIG. 27 in a guide-in mode, consistent with certain disclosed embodiments;

FIG. 29 illustrates a schematic view of an antenna structure with the multiple radiation area in accordance with the embodiment of the present disclosure;

FIG. 30 is schematic view showing the antenna radiation pattern corresponding to the grounded plane current distribution of antenna structure of FIG. 28, consistent with certain disclosed embodiments;

FIG. 31 illustrates a schematic view of an antenna structure with the RF current dragger of FIG. 29 in a guide-in mode in accordance with the embodiment of the present disclosure;

FIG. 32 is schematic view showing the antenna radiation pattern corresponding to the grounded plane current distribution of antenna structure of FIG. 31 in a guide-in mode, consistent with certain disclosed embodiments;

FIG. 33 illustrates a schematic view of an antenna structure with the polygonal grounded plane in accordance with the embodiment of the present disclosure;

FIG. 34 illustrates a schematic view of an antenna structure with the polygonal grounded plane disposed at the wall in accordance with another embodiment of the present disclosure;

FIG. 35 illustrates a schematic view of another antenna structure with the polygonal grounded plane disposed at the wall in accordance with another embodiment of the present disclosure; and

FIG. 36 illustrates a schematic view of another antenna structure with the polygonal grounded plane disposed at the wall in accordance with another embodiment of the present disclosure.

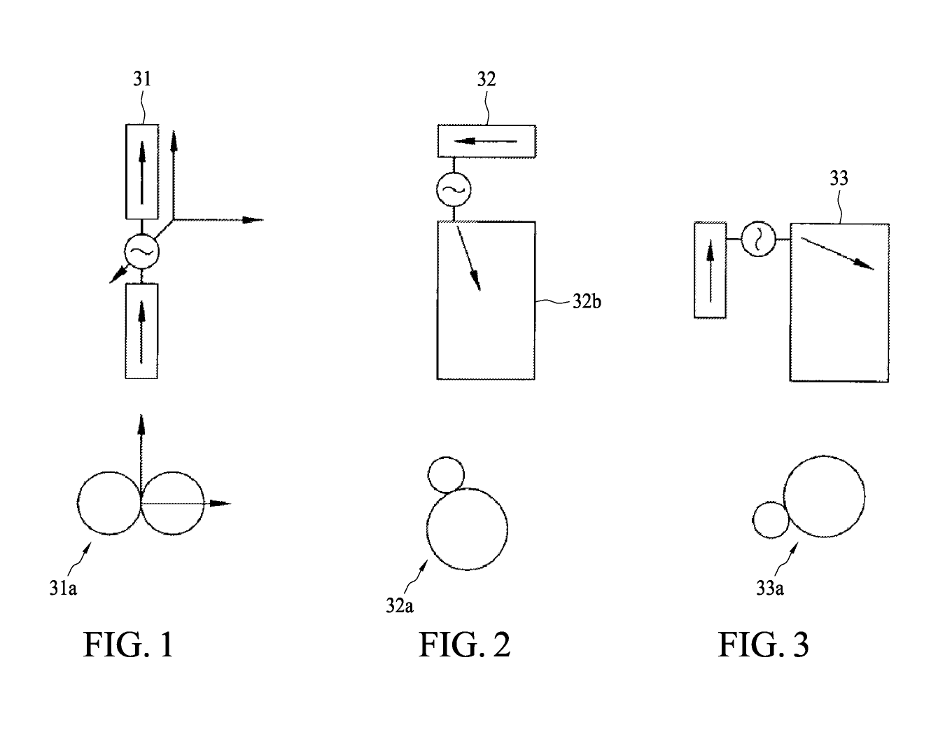

### DETAILED DESCRIPTION

The present disclosure is directed to an antenna structure with reconfigurable radiation patterns. The antenna structure includes a grounded plane, at least one active antenna and at least one RF current dragger. The at least one RF current dragger includes at least one switch component. The at least one active antenna electrically connected to a RF signal source. The at least one RF current dragger electrically couples to the grounded plane. The at least one active antenna and the at least one RF current dragger is disposed at two edges of the grounded plane or adjacent to two edges of the grounded plane. The two edges form an angle with respect to one another. The grounded plane of the antenna structure may be a part of radiator of the antenna.

In an antenna operation bandwidth, at least one switch component is configured to adjust a resonance frequency of the at least one RF current dragger so as to either guide in or cut off the RF current at the grounded plane to or from the at least one RF current dragger so as to form multiple radiation patterns.

In another embodiment, at least one switch component is disposed between the grounded plane and the at least one RF current dragger and configured to either guide the RF current at the grounded plane into at least one RF current dragger through a short-circuit status or to cut off the RF current at the grounded plane from the at least one RF current dragger through the open-circuit status.

In order to make the present disclosure completely comprehensible, detailed steps and structures are provided in the following description. Obviously, implementation of the present disclosure does not limit special details known by persons skilled in the art. In addition, known structures and steps are not described in details, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed embodiments, and is defined by the claims. The following description of the disclosure accompanies drawings, which are incorporated in and constitute a part of this specification, and illustrate embodiments of the disclosure, but the disclosure is not limited to the embodiments. In addition, the following embodiments can be properly integrated to complete another embodiment. References to “one embodiment,” “an embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

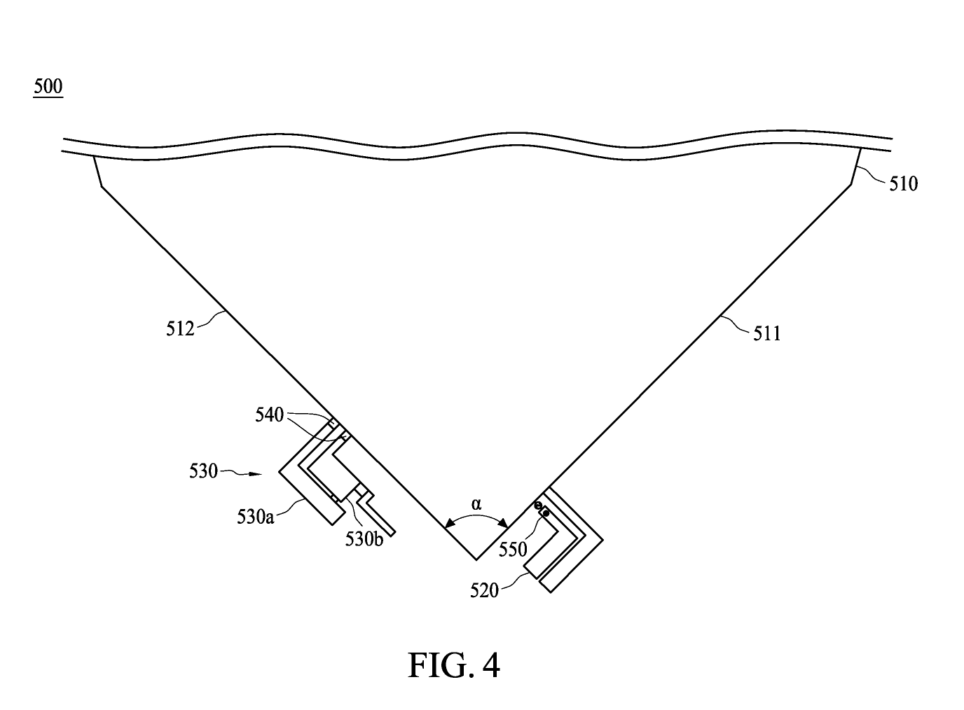

In the embodiment shown in FIG. 4, the antenna structure 500 with reconfigurable radiation patterns includes a grounded plane 510, an active antenna 520, an RF current dragger 530 and a switch component 540.

The grounded plane 510 includes a first edge 511 and a second edge 512. The first edge 511 and the second edge 512 form an angle α with respect to one another. The angle α, in the embodiment, is substantially 90° so as to provide a preferable radiation pattern coverage resulted from the active antenna 520 and the RF current dragger 530. In other embodiments (not shown), the angle α is not limited to 90° and selected from 175°, 130°, 125°, 108°, 85° or 60° in accordance with different designs.

In the embodiment, the length of the grounded plane 510 may be equal to the length of the first edge 511 and the second edge 512. The length of the grounded plane 510 ranges from one-quarter to five wavelengths of the operation center frequency of the antenna structure 500. In addition, the length of the first edge 511 may be the same as or distinguishable from that of the second edge 512. In the embodiment, the operation center frequency of the antenna structure 500 may, but not limited to, be 5.5 GHz. The operation bandwidth of the antenna structure 500 may range from 5.1 GHz to 5.9 GHz.

In the embodiment shown in FIG. 4, the active antenna 520 is disposed adjacent to the first edge 511. The term ‘adjacent’ in this specification means to be electrically coupled or electrically connected. The right-portion metal structure of the active antenna 520 is one part of the active antenna 520. Such right-portion metal structure is electrically connected to the grounded plane 510. In the other embodiment (not shown), the right-portion metal structure may be not electrically connected to the grounded plane 510, but electrically coupled to the grounded plane 510. Since the right-portion metal structure of the active antenna 520 is a part of the active antenna 520, the electromagnetic energy will be coupled to the right-portion metal structure so that the active antenna 520 can be operated with wide bandwidth.

In the embodiment, the active antenna 520 is electrically connected to the positive terminal of the RF current signal source, while the negative terminal of the RF current signal source is connected to the grounded plane 510. The single feeding point 550 of the RF signal source is electrically connected to the positive terminal thereof and is disposed at the active antenna 520 which is adjacent to the first edge 511. In other words, the signal feeding point 550 is disposed in relative to the grounded plane 510, while the RF signal source is grounded on the grounded plane 510. Since the active antenna 520 of the present disclosure has a single feeding point 550 for transmitting radio frequency (RF) signal, the present disclosure is distinguishable from the technology which utilizes a feeding network to connect multiple antenna feeding points and switches signals toward different antennas. Since a single antenna of the foregoing technology transmits a single radiation pattern instead of multiple radiation patterns and is required to increase feeding points for forming multiple radiation patterns, the present disclosure utilizing a single feeding point is distinguishable from the foregoing technology utilizing multiple feeding points for forming multiple patterns.

In the embodiment shown in FIG. 4, the RF current dragger 530 is disposed adjacent to the second edge 512. The resonant length of the RF current dragger 530 is substantially equal to one-quarter wavelength of the operation center frequency of the antenna structure 500. The location of the RF current dragger 530 is relied upon the location of the single feeding point 550. Particularly, the RF current dragger 530 is disposed at a circular area whose center is the location of the single feeding point 550. The radius of the circular area ranges from one-quarter to one wavelength of the operation center frequency of the antenna structure 500. Thus, the intersected location between the circle of the single feeding point 550 and the second edge 512 is the location of the RF current dragger 530. More particularly, a switch component 540 is disposed between the RF current dragger 530 and the grounded plane 510. In other words, in the embodiment, the RF current dragger 530 is not directly connected to the grounded plane 510. In other embodiments (not shown), the RF current dragger 530 may directly connect to the grounded plane 510 in response to different designs.

In the embodiment shown in FIG. 4, although the RF current dragger 530 does not directly connect to the grounded plane 510, the RF current dragger 530 is electrically connected to the grounded plane 510 through a switch component 540. In other words, the switch component 540 is electrically coupled between the RF current dragger 530 and the grounded plane 510. In the embodiment, the switch component 540 may be a diode. In other embodiments (not shown), the switch component 540 is selected from a bipolar junction transistor, a field effect transistor, a variable capacitor and a micro electro mechanical systems (MEMS) switch.

Since the switch component 540 is controlled by a control signal for turning on or turning off, the present disclosure does not require power dividers, phase shifters, amplitude adjusters or complicated controllers to turn on or turn off the switch component 540. The control signal could be a direct current (DC) signal, for example.

The antenna structure 500 further includes a controller (not shown). The controller is configured to generate a control signal. The switch component 540 is capable of forming either an open-circuit status or a short-circuit status between the RF current dragger 530 and the grounded plane 510 in response to the control signal. During the short circuit status, the switch component 540 guides the RF current at the grounded plane 510 into the RF current dragger 530. During the open-circuit status, the switch component 540 cuts off the RF current at the grounded plane 510 from the RF current dragger 530. Particularly, after control signal transmits to the switch component 540, the switch component 540 will stay at either the guide-in mode or the cut-off mode in accordance with the control signal level. In the guide-in mode, the switch component 540 electrically connects to the grounded plane 510 and the RF current dragger 530 through the short-circuit status. The RF current at the grounded plane 510 induced by the RF signal source will pass through or be guided through the switch component 540 into the RF current dragger 530. In the cut-off mode, the switch component 540 will electrically isolate the grounded plane 510 and the RF current dragger 530. In other words, since the input impedance of the RF current dragger 530 may form an open-circuit status so as to cut off the RF current at the grounded plane 510 from the corresponding RF current dragger 530, the RF current at the grounded plane 510 cannot be guided into the RF current dragger 530. Because the switch component 540 is configured to either guide the RF current at the grounded plane 510 into the RF current dragger 530 or cut off the RF current from the RF current dragger 530, the switch component 540 of the present disclosure may either guide the RF current into the RF current dragger 530 or cut off the RF current from the RF current dragger 530 so as to form two distinguishable radiation patterns.

In another embodiment, the guide-in mode and the cut-off mode is determined by the resonance of the RF current at the RF current dragger within the operation bandwidth.

For instance, in the guide-in mode, since the RF current at the RF current dragger is resonated within the operation band of the antenna structure so that the input impedance against the RF current is low, the RF current will be guided into the RF current dragger. In the cut-off mode, because the input impedance against the RF current is at high level, the RF current is cut off from the RF current dragger.

In the embodiment shown in FIG. 4, when the RF current will be guided into the RF current dragger 530, the radiation pattern is the linear superposition of the radiation patterns formed by the RF current distributions of the two active antennas (i.e., one is the active antenna, and the other one is the active antenna replacing the RF current dragger 530), where relative phase and amplitude of the RF current dragger 530 to the active antenna RF current are factors of the linear coefficient of the radiation pattern formed by the RF current distribution of the active antennas. For example, the radiation pattern of the active antenna is E₁(θ, φ), while that of the other active antenna is E₂(θ, φ). Thus the radiation pattern (Eₜₒₜₐₗ) both active antennas can be expressed as the following formula:

(Eₜₒₜₐₗ)=E₁(θ,φ)+E₂(θ,φ)exp(α₂+jβ₂)

Therefore, relative phase and amplitude of the RF current dragger 530 are factors of the linear coefficient of the radiation pattern formed by the RF current distribution of the active antenna 520.

Therefore, the disclosed embodiments may affect the RF current on the grounded plane 510 through the switch between the guide-in mode and the cut-off mode of the switch component 540 to either guide in or cut off the RF current. Different configuration combinations allow the antenna structure 500 to form different RF current distributions. The change of RF current distribution on the grounded plane 510 will affect the far field pattern (in directivity) and the near field electromagnetic energy distribution of the antenna, such as specific absorption rate (SAR) of electromagnetic energy per mass unit. Therefore, the antenna structure 500 will have the reconfigurable patterns.

In comparison with the technique of prior arts changing antenna radiation pattern by electromagnetic coupling, the disclosed exemplary embodiments does not impose any restriction on the polarization and distance between the active antenna and the RF current dragger. Hence, the disclosed exemplary embodiments may be applicable to the low profile antenna structure.

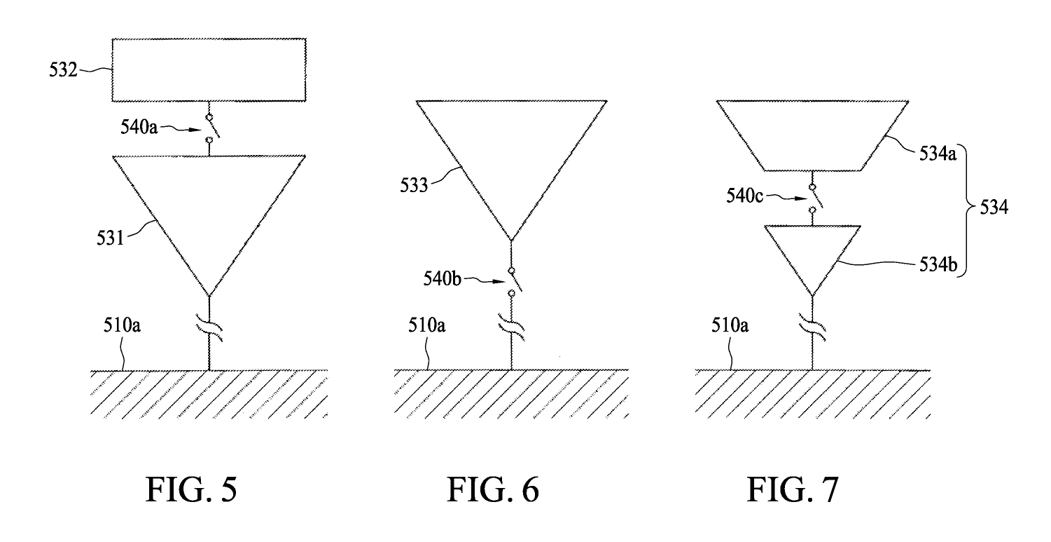

The RF current dragger of the present disclosure may be selected from, for example, pseudo antenna type and resonator type. FIGS. 5-7 show three embodiments of pseudo antenna type RF current dragger, consistent with certain disclosed embodiments, where the switch component of the RF current dragger can be, for example, a switch or an adjustable load. The following examples use a switch component of the RF current dragger for description.

In FIG. 5, the switch component 540a of the pseudo antenna type RF current dragger is located between pseudo antenna 531 and an extension 532 of the pseudo antenna 531. The pseudo antenna 531 is grounded on the grounded plane 510a. In FIG. 6, the switch component 540b of the pseudo antenna type RF current dragger is located between the pseudo antenna 533 and the grounded plane 510a. This embodiment is similar to the left-handed branch 530a of the RF current dragger 530 shown in FIG. 4. In FIG. 7, the switch component 540c of pseudo antenna type RF current dragger is located inside the pseudo antenna 534; in other words, the switch component 540c is located between two segments 534a, 534b of the pseudo antenna wherein the segment 534b is grounded on the grounded plane 510a. The aforementioned pseudo antenna may be a conductor, such as metal plate. RF current may be coupled or directly flow into the pseudo antenna.

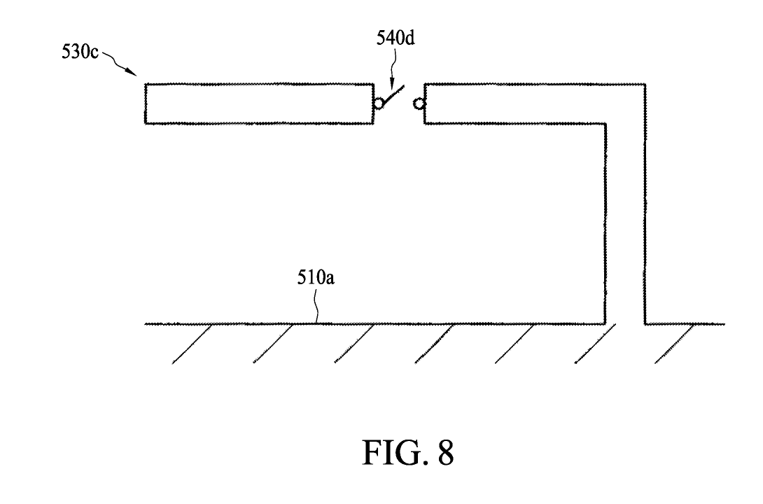

FIG. 8 shows a schematic view of a monopole type RF current dragger according to the present disclosure. As shown in FIG. 8, the switch component 540d of monopole type RF current dragger 530c is located between two segments of L-arm. L-arm has one termination grounded to the grounded plane 510a. Referring FIG. 4, since the right-handed branch 530b of the RF current dragger 530 is similar to this monopole type RF current dragger, the switch component 540 of the right-handed branch 530b may be disposed between the grounded plane 510 and the RF current dragger 530 or located between two segments of L-arm of the RF current dragger shown in FIG. 8. In summary, the foregoing monopole pseudo antenna type RF current dragger may form different RF current draggers in accordance with different designs.

Furthermore, the resonator type RF current dragger may be a multi-port resonator and may be equivalent to a circuit including an inductor and a capacitor. Such circuit is configured to switch the resonant frequency of the RF current dragger so as to either guide the RF current at the grounded plane into the RF current dragger or cut off the RF current from the RF current dragger.

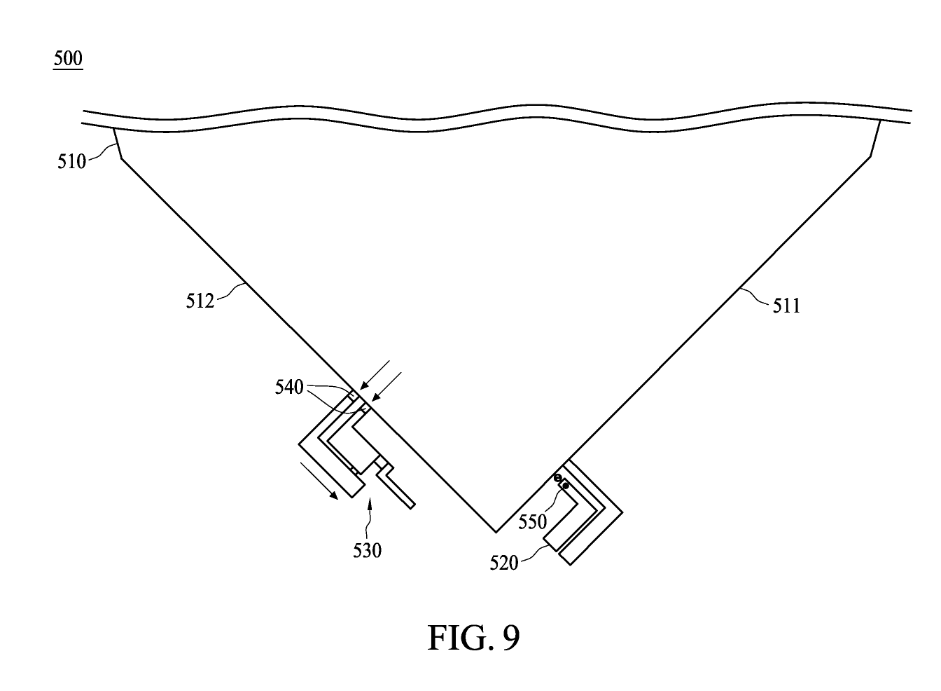

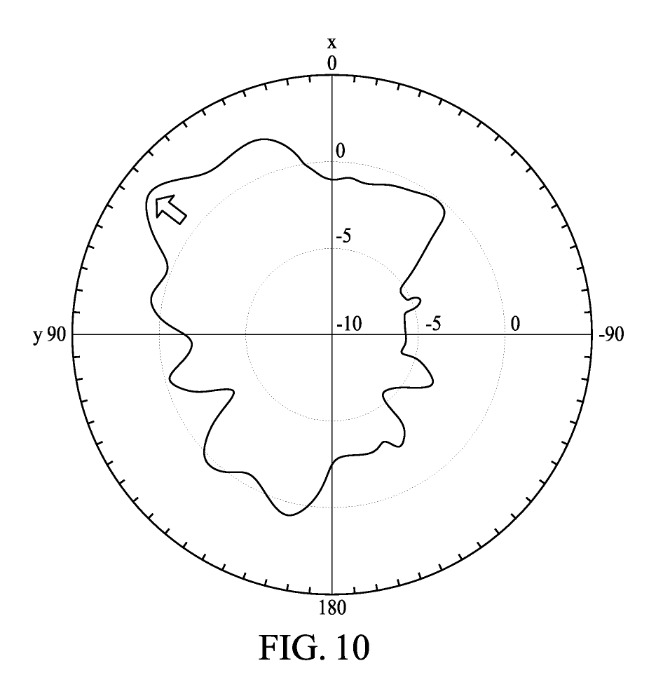

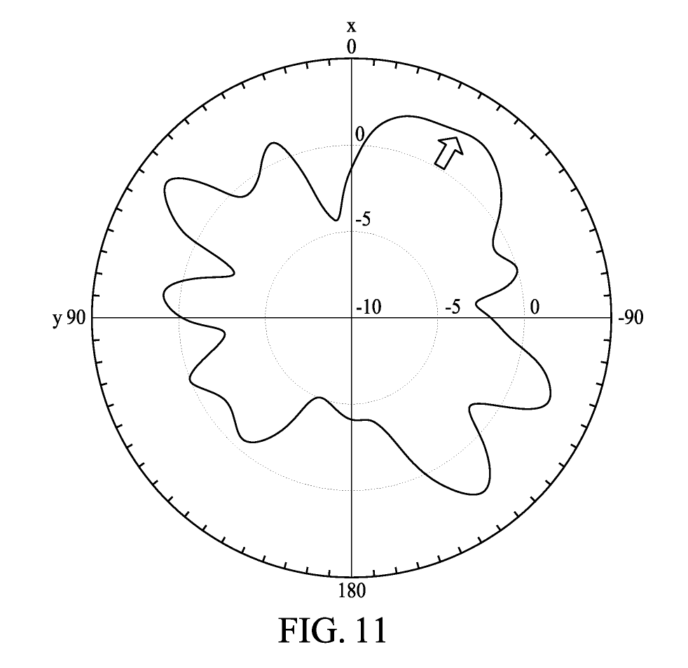

Referring FIG. 4, in the cut-off mode, the RF current at the grounded plane 510 cannot be guided into the RF current dragger 530. As shown in FIG. 10, in the cut-off mode of the antenna structure 500 shown in FIG. 4, the main beam direction of the antenna radiation pattern faces 55° (as indicated by the arrow). Referring FIG. 9, in the guide-in mode, the RF current at the grounded plane 510 (as indicated by arrows) passes through or be guided through the switch component 540 into the RF current dragger 530. The operation center frequency of the antenna structure 500 is, but not limited to, 5.5 GHz. In other words, the wavelength of the antenna structure 500 is 54.5 mm. As shown in FIG. 11, in the guide-in mode of the antenna structure 500 shown in FIG. 9, the main beam direction of the antenna radiation pattern substantially faces −35° (as indicated by the arrow). In other words, the antenna structure may be configured to have the main beam facing 55° direction or −35° direction. In summary, when the RF current at the grounded plane 510 is guided into the RF current dragger 530 in the guide-in mode, the antenna structure 500 transmits a first radiation pattern (the main beam thereof facing −35° direction). When the RF current at the grounded plane 510 is cut off from the RF current dragger 530 in the cut-off mode, the antenna structure 500 transmits a second radiation pattern (the main beam thereof facing 55° direction). Thus, the first radiation pattern is distinguishable from the second radiation pattern. In other words, when the RF current at the grounded plane 510 is guided into the RF current dragger 530, the RF current dragger 530 is resonated within the operation bandwidth of the active antenna so as to switch the second radiation pattern to the first radiation pattern.

FIG. 4 and FIG. 9 illustrate the embodiments disclosing a single RF current dragger. In another embodiment (not shown), the antenna structure may include a plurality of the RF current draggers, each of which may be controlled by the switch components, respectively. Since the radiation pattern is the linear superposition of the radiation patterns formed by the RF current distributions of the active antenna and n RF current draggers, one of which may form two radiation patterns, the antenna structure with n RF current draggers may form 2ⁿ radiation patterns.

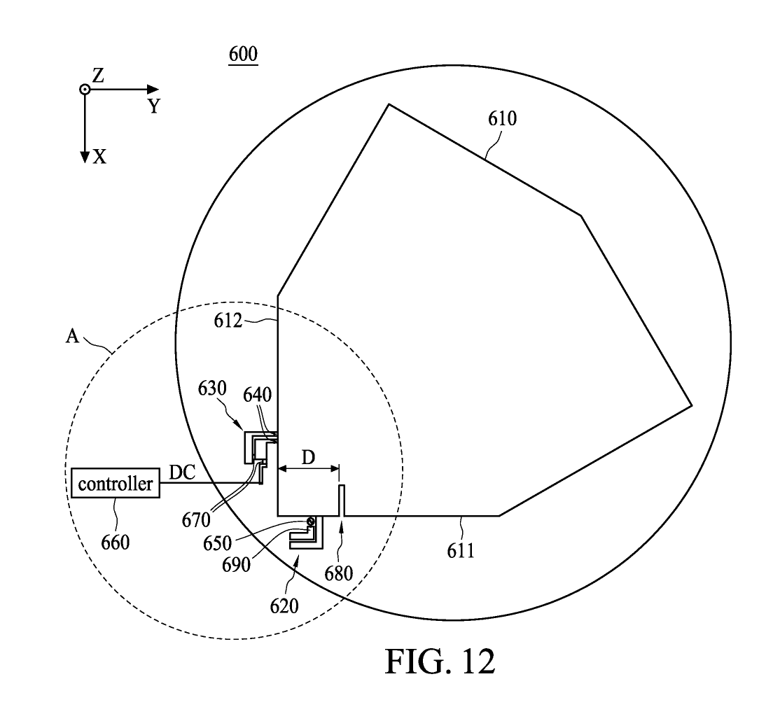

As shown in FIG. 12, the antenna structure 600 includes a grounded plane 610, an active antenna 620, an RF current dragger 630, a switch component 640, an RF signal source 650, a controller 660, an inductor 670 and a slot 680.

The grounded plane 610, the active antenna 620, the RF current dragger 630 and the switch component 640 are similar to the above-identified grounded plane 510, the active antenna 520, the RF current dragger 530 and the switch component 540, respectively.

In the embodiment shown in FIG. 12, the operation center frequency of the RF signal source 650 may, but not limited to, be 5.5 GHz. In other words, the wavelength of the antenna structure 600 is 54.5 mm. The operation bandwidth of the antenna structure 600 may range from 5.1 GHz to 5.9 GHz.

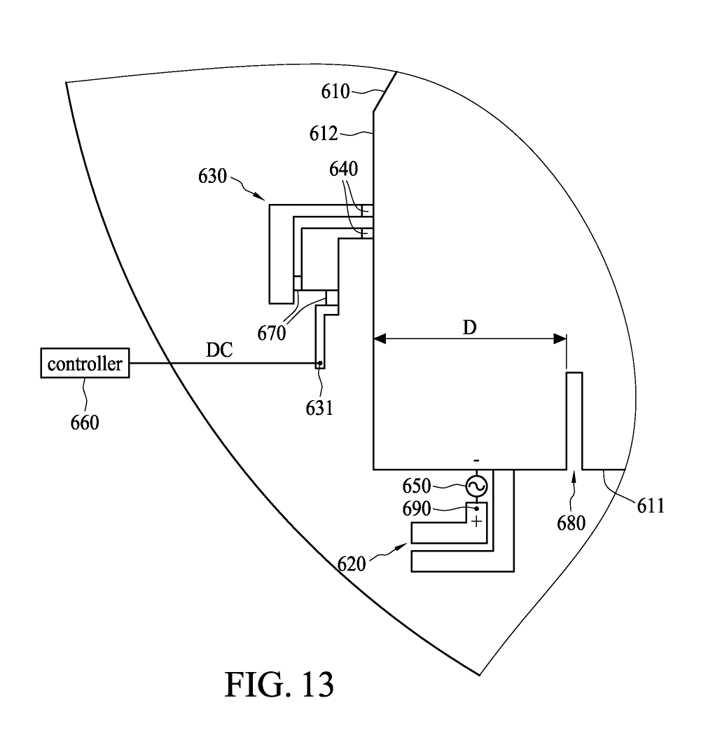

FIG. 13 is the enlarged view of the circuit A in FIG. 12. As shown in FIG. 13, the RF signal source 650 transmits the RF signal to the active antenna 620 through the single feeding point 690. Particularly, the RF signal source 650 transmits the RF signal to the single feeding point 690 through the positive terminal (indicated as +) of the transmitting line, while the negative terminal (indicated as −) of the transmitting line is electrically connected to the grounded plane 610.

Moreover, the control line (not shown) connected to the controller 660 electrically connects to a terminal 631 of the RF current dragger 630. The control signal transmitted by the control line is conducted into the terminal 631 and then transmits to the switch component 640 through the inductor 670. The inductor 670 is configured to isolate the RF signal from the RF signal source 650 which is electrically coupled to the terminal 631. In the embodiment, the switch component 640 is disposed between the grounded plane 610 and the RF current dragger 630. Thus, the switch component 640 controlled by control signal may switch the guide-in mode to the cut-off mode, and vise versa so as to either guide the RF current into the RF current dragger 630 or cut off the RF current from the RF current dragger 630.

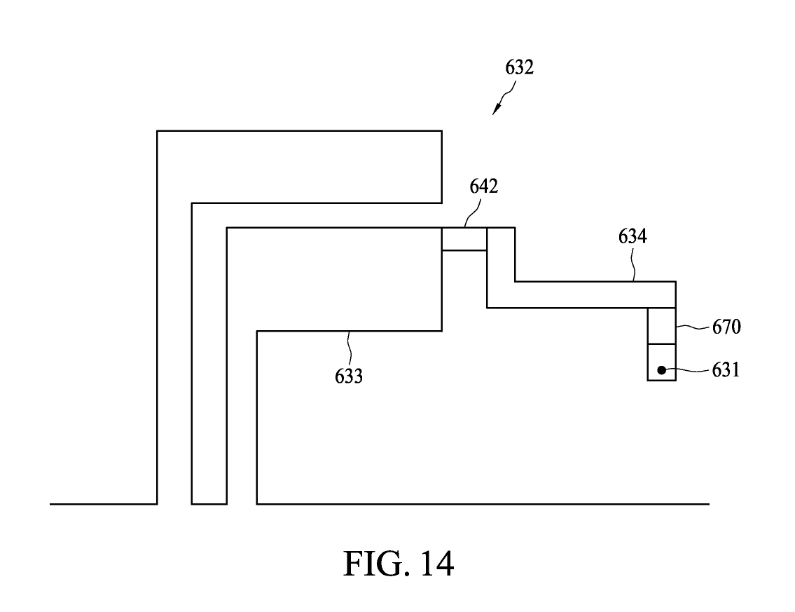

In another embodiment shown in FIG. 14, the switch component 642 of the RF current dragger 632 is disposed between the body 633 of the RF current dragger 632 and an extending portion 634 of the RF current dragger 632. The inductor 670 is disposed between the terminal 631 and the extending portion 634 of the RF current dragger 632.

In the embodiment shown in FIG. 14, in the cut-off mode, the switch component 642 forms an open-circuit status between the body 633 and the extending portion 634. In the embodiment, the body 633 is resonated within the operation bandwidth of the active antenna 620 so as to guide the RF current into the body 633. When the control signal transmits to the switch component 642 through the terminal 631 and the inductor 670 so as to turn on the switch component 642, a short-circuit status is formed between the body 633 and the extending portion 634. The short-circuit status will cut off the RF current from the RF current dragger 632. This is because that the short-circuit status increases the resonant length of the RF current dragger 632 to the active antenna 620 in the operation bandwidth so as to reduce the resonant frequency of the RF current dragger whose resonant frequency is lower than the operation bandwidth of the active antenna 620 to cut off the RF current from the RF current dragger 632.

In the embodiment shown in FIG. 12, the operation center frequency of the antenna structure 600 may, but not limited to, be 5.5 GHz. In other words, the wavelength of the antenna structure 600 is 54.5 mm. The length of the slot 680 is equal to one-quarter wavelength (about 13.625 mm) of the operation center frequency of the antenna structure 600. The slot 680 is disposed at a circular area. The location of the single feeding point 690 is located at the center of the circular area while the radius of the circular area ranges from one wavelength (about 54.5 mm) of the operation center frequency of the antenna structure 600. In the embodiment, the slot 680 is located at a intersected position between the circle of the single feeding point 690 and the first edge 611. In other embodiments (not shown), since the slot 680 is not necessary formed at the first edge 611 or the second edge 612, the slot 680 may be formed inside the grounded plane 610. Moreover, the location of the slot 680 may affect the main beam direction of the radiation pattern. Since the RF currents on grounded plane 610 around the slot 680 perturbed changes the equivalent grounded plane of the antenna structure 600, the main beam directions of the first radiation pattern (in the guide-in mode) and the second radiation pattern (in the cut-off mode) of the antenna structure 600 are affected.

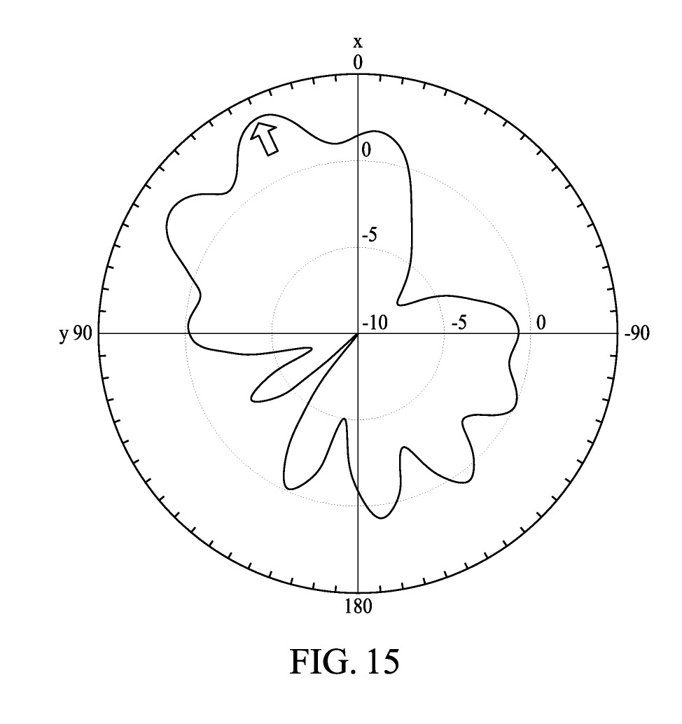

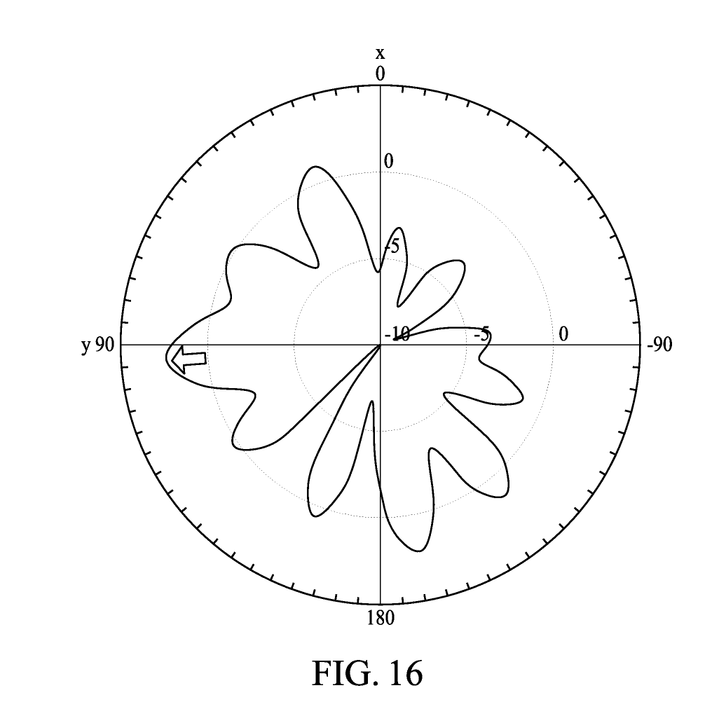

As shown in FIG. 12, the distance between the slot 680 and the second edge 612 is defined as D length. As shown in FIG. 15, when D length is equal to 0.25 wavelength, the main beam direction of the radiation pattern substantially is toward 25° as indicated by the arrow. As shown in FIG. 16, when D length is equal to 0.45 wavelength, the main beam direction of the radiation pattern substantially faces 95° as indicated by the arrow. In summary, after the slot 680 is placed away from the single feeding point 690, the main beam direction of the radiation pattern is counterclockwisely shifted.

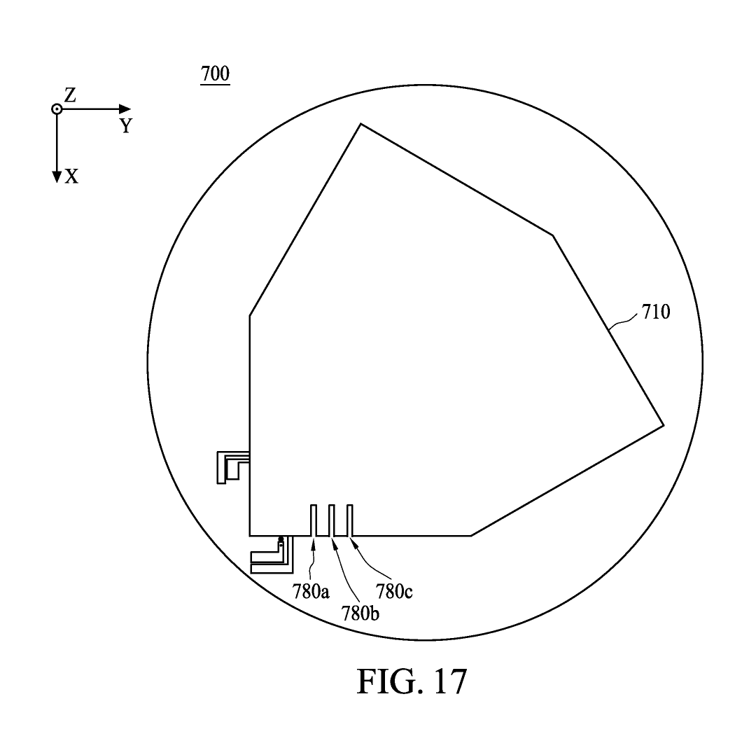

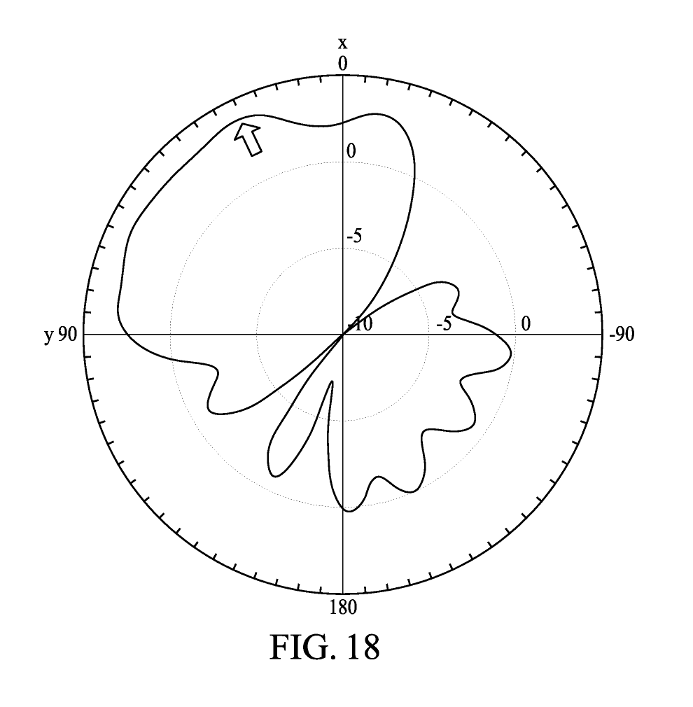

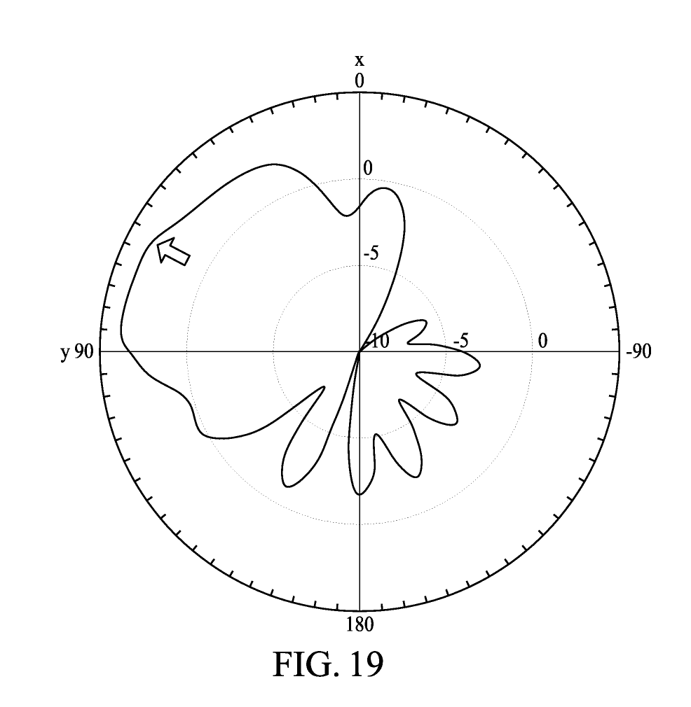

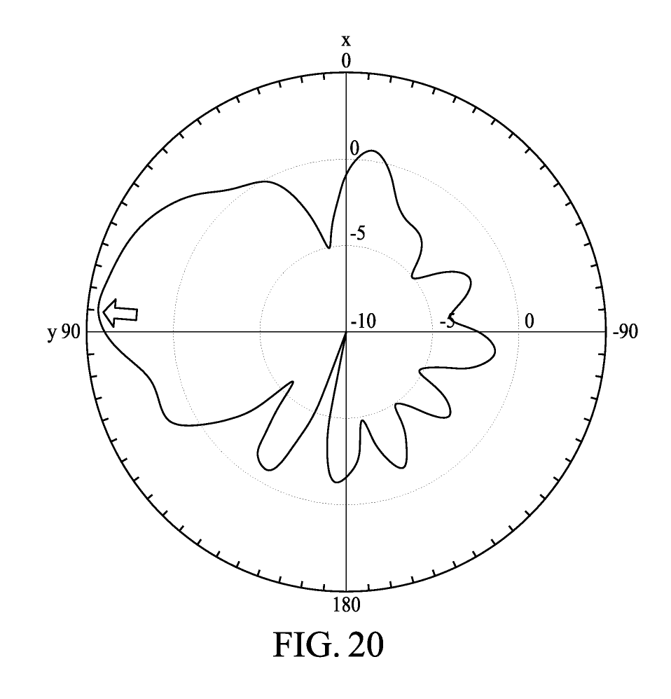

The above-mentioned embodiments illustrate how the location of a single slot affects the main beam direction of the radiation pattern. In the embodiment shown in FIG. 17, the operation center frequency may, but not limited to, be 5.5 GHz. In other words, the wavelength of the antenna structure 700 is 54.5 mm. The antenna structure 700 includes three slots 780a, 780b and 780c formed on the grounded plane 710. The slots 780a, 780b and 780c are spaced out 0.1 wavelength (about 5.45 mm). When the antenna structure (not shown) only includes the slot 780a, the main beam direction of the radiation pattern illustrated in FIG. 18 faces 25° as indicated by the arrow. When the antenna structure (not shown) includes two slots 780a, 780b, the main beam direction of the radiation pattern illustrated in FIG. 19 is toward 65° as indicated by the arrow. As shown in FIG. 17 and FIG. 20, when the antenna structure 700 includes three slots 780a, 780b and 780c, the main beam direction of the radiation pattern faces 88° as indicated by the arrow. In summery, when the number of the slots increases, the main beam direction of the antenna pattern will shift from 25° to 88°. Therefore, the number of the slots causes the counterclockwise shift of the main beam direction.

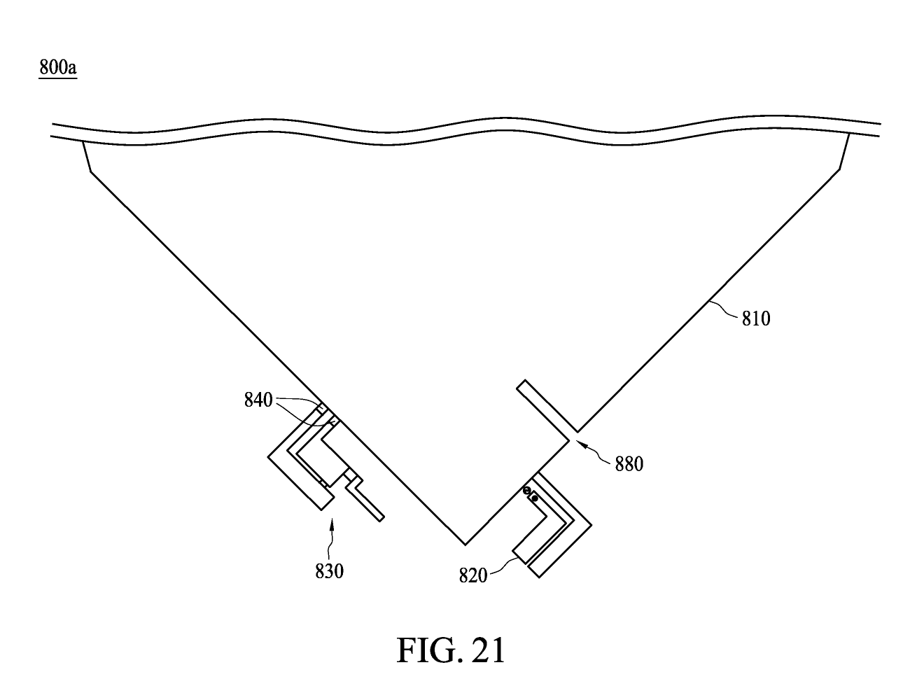

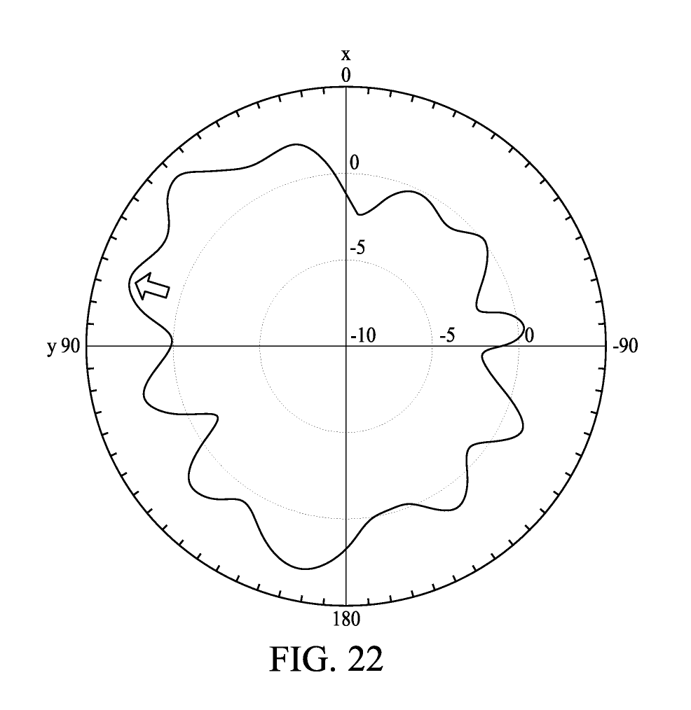

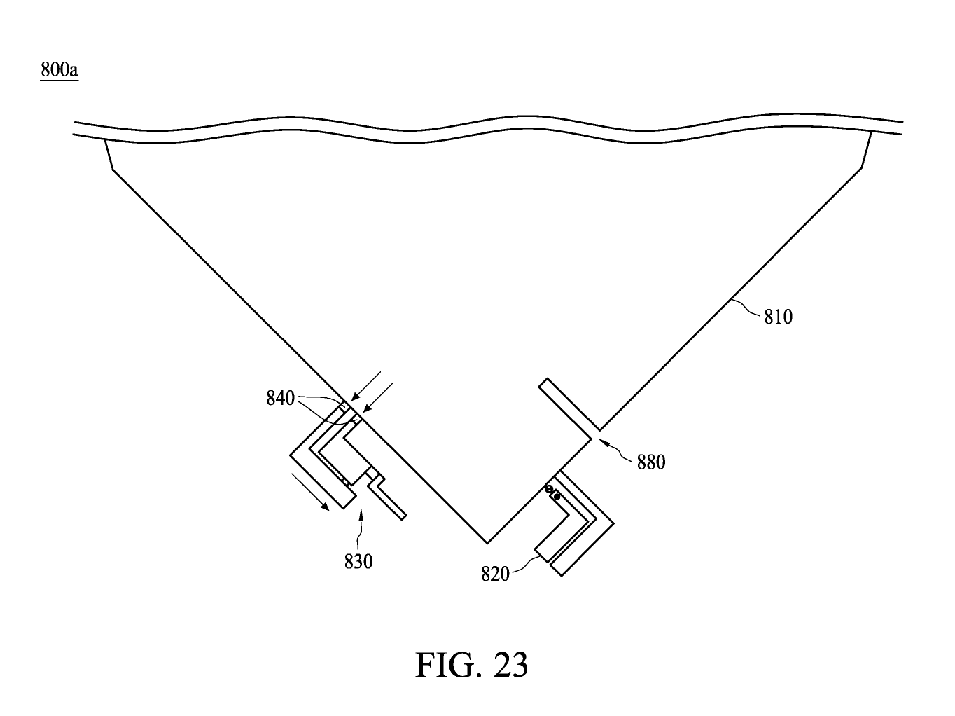

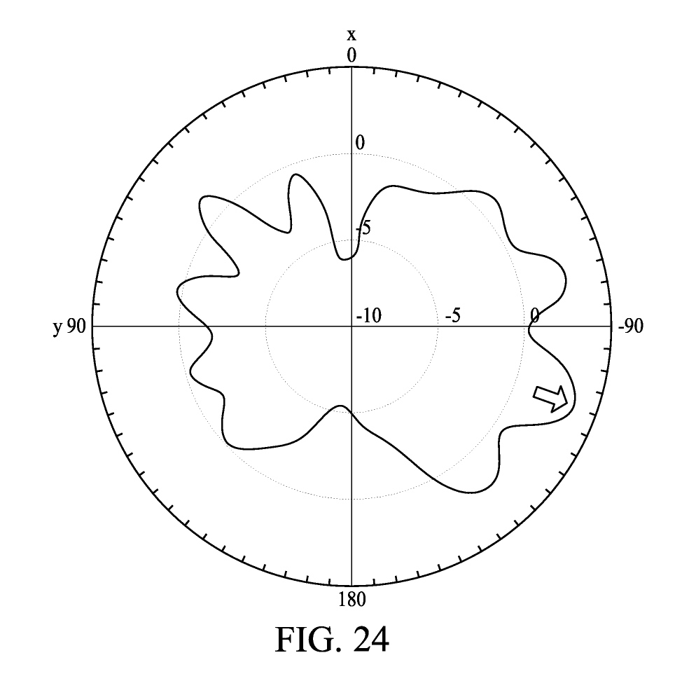

The above-identified embodiment illustrates the relationship between the number of the slots and the shift of the main beam direction. The following embodiments further explain that how the slot of the antenna structure affects the main beam direction between the guide-in mode and the cut-off mode. The antenna structure 800a shown in FIG. 21 is similar to the antenna structure 500 shown in FIG. 9, but the antenna structure 800a further includes a slot 880. In the cut-off mode of the antenna structure 800a, since the RF current at the grounded plane 810 cannot be guided into the RF current dragger 830 through the switch component 840, such RF current dragger 830 cannot perform like an active antenna. In the embodiment, the radiation pattern shown in FIG. 22 is formed by the RF current distribution resulted from the active antenna 820 and the slot 880 shown in FIG. 21. As shown in FIG. 22, in the cut-off mode of the antenna structure 800a, the main beam direction of the radiation pattern faces 75° as indicated by the arrow. In the embodiment, the radiation pattern shown in FIG. 22 is formed by the RF current distribution resulted from the active antenna 820, the RF current dragger 830 and the slot 880. Compared with the main beam directions of FIG. 10 and FIG. 22, it proves that the slot 880 causes the main beam direction of the radiation pattern to counterclockwisely shift. As shown in FIG. 23, in the guide-in mode of the antenna structure 800a, when the RF current (as indicated by the arrows) of the grounded plane 810 is guided into the RF current dragger 830 through the switch component 840, the RF current dragger 830 is similar to another active antenna. As shown in FIG. 24, in the guide-in mode of the antenna structure 800a, the main beam direction of the radiation pattern faces −110° as indicated by the arrow.

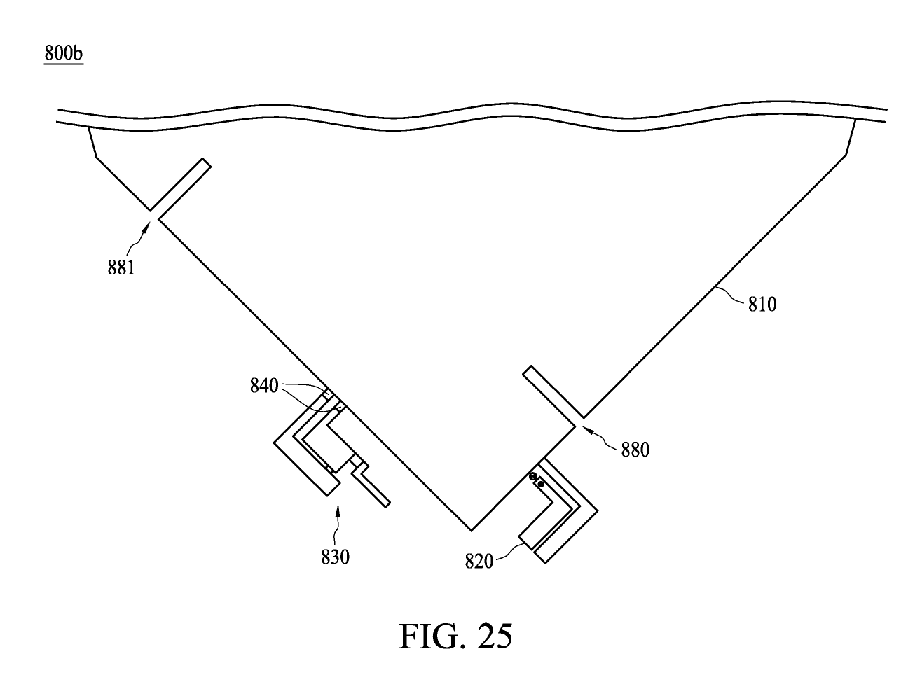

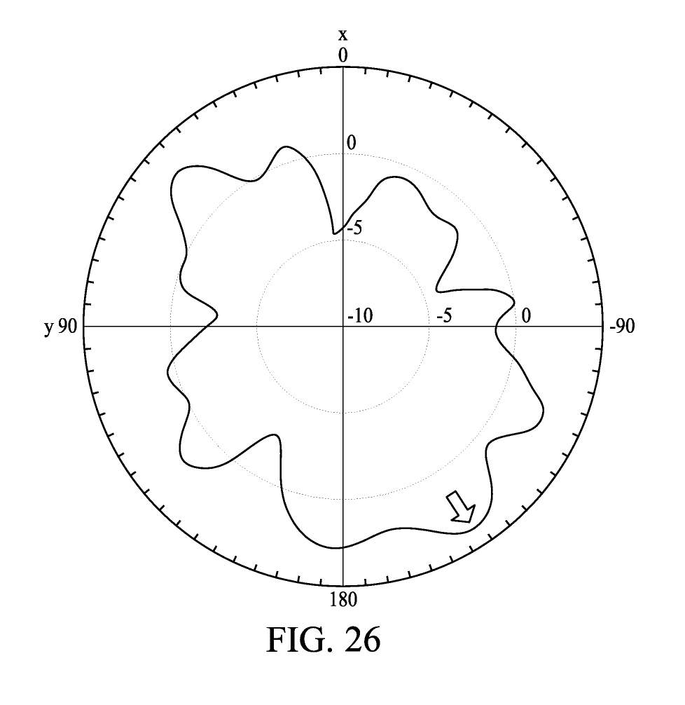

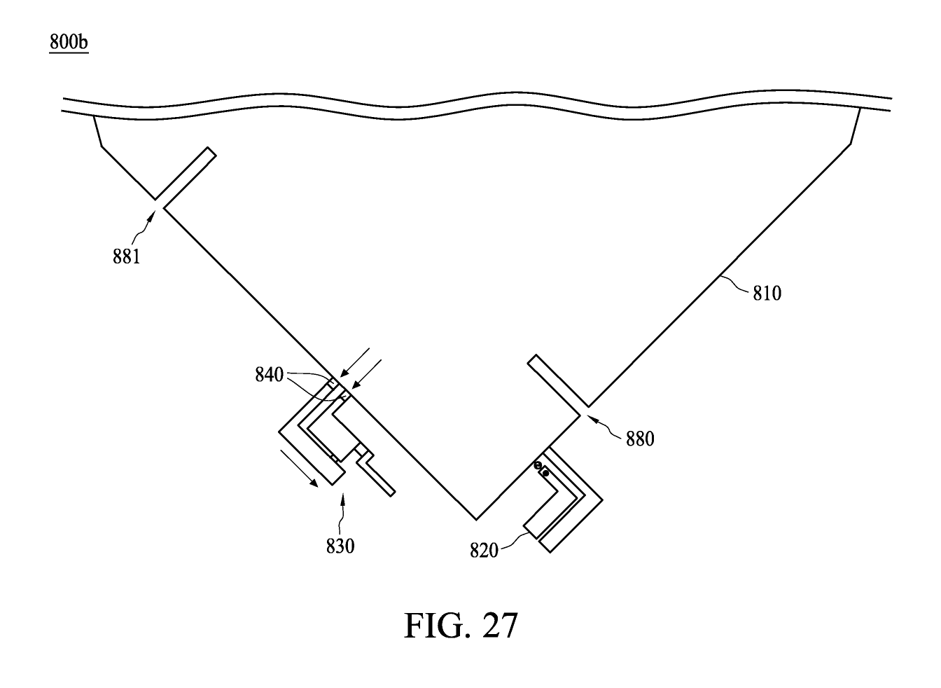

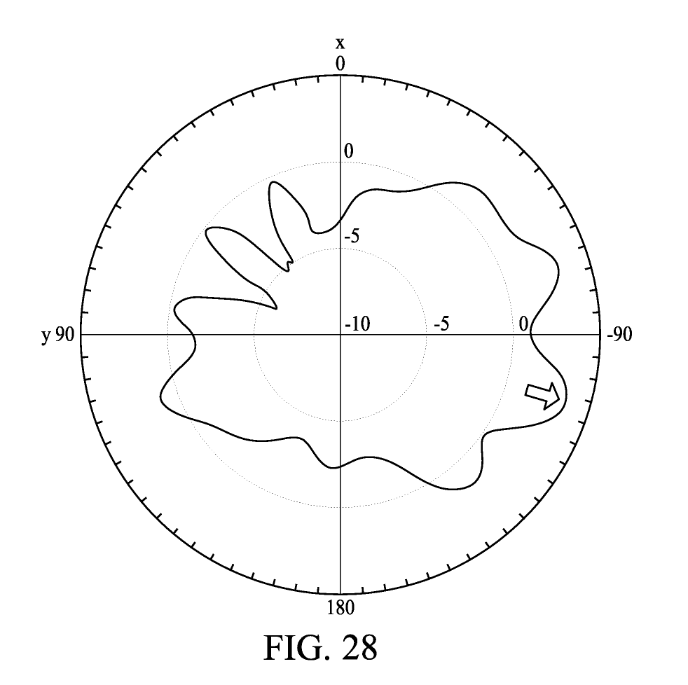

Furthermore, the slot is not necessary located at an edge where the active antenna is located. The antenna structure 800b shown in FIG. 25 is similar to the antenna structure 800a shown in FIG. 21, but the antenna structure 800b further includes another slot 881. In the cut-off mode of the antenna structure 800b, when the RF current at the grounded plane 810 cannot be guided into the RF current dragger 830 through the switch component 840, the RF current dragger 830 cannot perform like the active antenna. In the embodiment, the radiation pattern shown in FIG. 26 is formed by the RF current distribution resulted from the active antenna 820 and the slots 880 and 881. As shown in FIG. 26, in the cut-off mode of the antenna structure 800b, the main beam direction of the radiation pattern faces −145° as indicated by the arrow. As shown in FIG. 27, in the guide-in mode of the antenna structure 800b, when the RF current (as indicated by the arrows) of the grounded plane 810 is guided into the RF current dragger 830 through the switch component 840, the RF current dragger 830 is similar to another active antenna. In the embodiment, the radiation pattern shown in FIG. 28 can be formed by RF current distribution resulted from the active antenna 820, the RF current dragger 830 and the slots 880 and 881. As shown in FIG. 28, in the guide-in mode of the antenna structure 800a, the main beam direction of the radiation pattern faces −105° as indicated by the arrow. In other words, the antenna structure may be configured to have the main beam facing −145° direction or −105° direction.

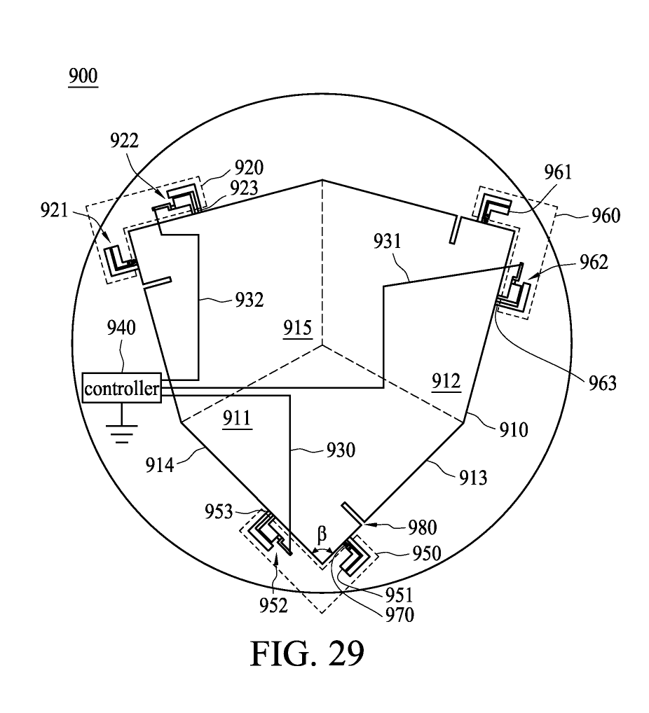

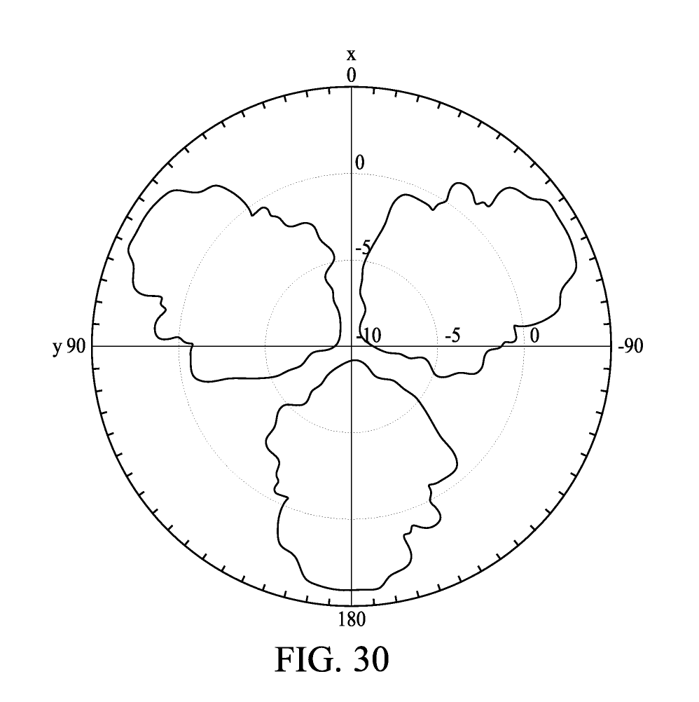

In the embodiment shown in FIG. 29, an antenna structure 900 with reconfigurable radiation patterns includes a grounded plane 910, a first radiation area 950, a second radiation area 960, a third radiation area 920, a first control line 930, a second control line 931, and a third control line 932.

The grounded plane 910 includes a first area 911, a second area 912 and a third area 915. The first area 911 is located adjacent to the second area 912. The first area 911 includes a first edge 913 and a second edge 914. The first edge 913 and the second edge 914 form an angle β with respect to one another. The range of the angle β is similar to the range of the foregoing angle α.

The first radiation area 950 is disposed adjacent to the first area 911 and includes a first active antenna 951, a first RF current dragger 952 and a first switch component 953. The first active antenna 951, the first RF current dragger 952 and the first switch component 953 are similar to the foregoing active antenna 620, RF current dragger 630 and switch component 640, respectively. Thus, the resonant length of the first RF current dragger 952 is substantially equal to one-quarter wavelength of the operation center frequency. The first RF current dragger 952 is disposed at a circular area. The single feeding point is located at the center of the circular area whose radius ranges from one-quarter to one wavelength of the operation center frequency of the antenna structure 900.

The second radiation area 960 is disposed adjacent to the second area 912. The second active antenna 961, the second RF current dragger 962 and the second switch component 963 of the second radiation area 960 are similar to the foregoing active antenna 620, RF current dragger 630 and switch component 640, respectively. Thus, the length and location of the second RF current dragger 962 is similar to the length and location of the first RF current dragger 952.

In the embodiment shown in FIG. 29, the antenna structure 900 further includes a third radiation area 920, which is similar to the first radiation area 950. In addition, in the embodiment, the clockwise angle difference between the second radiation area 960 and the first radiation area 950 is 120°. Furthermore, the angle difference between the second radiation area 960 and the first radiation area 950 may be, but not limited to, 120°.

As shown in FIG. 29, the third area 915 is disposed adjacent to the first area 911 and the second area 912. The third radiation area 920 is disposed adjacent to the third area 915. The third active antenna 921, the third RF current dragger 922 and the third switch component 923 of the third radiation area 920 are similar to the active antenna 620, the RF current dragger 630 and the switch component 640, respectively. Thus, the length and location of the third RF current dragger 952 is similar to the length and location of the first RF current dragger 952. In the embodiment, the counterclockwise angle difference between the third radiation area 920 and the first radiation area 950 is 120°.

As shown in FIG. 29, the controller 940 is electrically connected to the first control line 930, the second control line 931 and the third control line 932. The first control line 930 is electrically connected to the terminal (not shown) of the first RF current dragger 952. Similarly, the second control line 931 is electrically connected to the terminal (not shown) of the second RF current dragger 962, while the third control line 932 is electrically connected to the terminal (not shown) of the third RF current dragger 922.

Since the first control line 930, the second control line 931 and the third control line 932 are electrically connected to the controller 940, the first control line 930, the second control line 931 and the third control line 932 may conduct the control signals from the controller 940, respectively. Thus, the first control line 930, the second control line 931 and the third control line 932 are configured to control the first switch component 953, the second switch component 963 and the third switch component 923, respectively.

In the embodiment, the first switch component 953 is disposed between the grounded plane 910 and the first RF current dragger 952. The second switch component 963 is disposed between the grounded plane 910 and the second RF current dragger 962. The third switch component 923 is disposed between the grounded plane 910 and the third RF current dragger 922. The first switch component 953, the second switch component 963 and the third switch component 923 are configured to switch to either the guide-in mode or the cut-off mode between the first RF current dragger 952, the second RF current dragger 962 and the third RF current dragger 922 and the grounded plane 910, respectively, in response to individual control signals. In the guide-in mode (forming the short-circuit status), the first switch component 953, the second switch component 963 and the third switch component 923 guide the RF current at the grounded plane 910 into the first RF current dragger 952, the second RF current dragger 962 and the third RF current dragger 922, respectively. In the cut-off mode (forming the open-circuit status), the first switch component 953, the second switch component 963 and the third switch component 923 cut off the RF current at the grounded plane 910 from the first RF current dragger 952, the second RF current dragger 962 and the third RF current dragger 922, respectively. For instance, when the first RF current dragger 952 and the second RF current dragger 962 stay at the guide-in mode, the third RF current dragger 922 controlled by the third control line 932 may stay at the cut-off mode, and vise versa. In the embodiment, the antenna structure 900 includes a first radiation area 950, a second radiation area 960 and a third radiation area 920. Since each of the radiation area may form two radiation patterns, the antenna structure 900 with three radiation area may form 2³ radiation patterns.

Furthermore, in another embodiment, the first RF current dragger 952, the second RF current dragger 960 and the third RF current dragger 922 may be designed similar to the embodiment shown in FIG. 14. The first control line 930, the second control line 931 and the third control line 932 can transmit the control signals of the controller 940, respectively. In addition, the first control line 930, the second control line 931 and the third control line 932 are configured to control the first switch component 953, the second switch component 963 and the third switch component 923, respectively. The first switch component 953, the second switch component 963 and the third switch component 923 adjust the resonant frequency of the first RF current dragger 952, the second RF current dragger 962 and the third RF current dragger 922, respectively, in response to individual control signals. In the embodiment, the RF current at the grounded plane 910 is either guided into the first RF current dragger 952, the second RF current dragger 962 and the third RF current dragger 922, respectively, or cut off from the first RF current dragger 952, the second RF current dragger 962 and the third RF current dragger 922, respectively, in response to individual resonant frequency of the first RF current dragger 952, the second RF current dragger 962 and the third RF current dragger 922.

In another embodiment, the first switch component 953, the second switch component 963 and the third switch component 923 may either guide the RF current at the grounded plane 910 into the first RF current dragger 952, the second RF current dragger 962 and the third RF current dragger 922, or cut off the RF current at the grounded plane 910 from the first RF current dragger 952, the second RF current dragger 962 and the third RF current dragger 922, respectively. Such switch components may be selected from bipolar junction transistor, field effect transistor, variable capacitor, diode and micro electro mechanical systems (MEMS) switch.

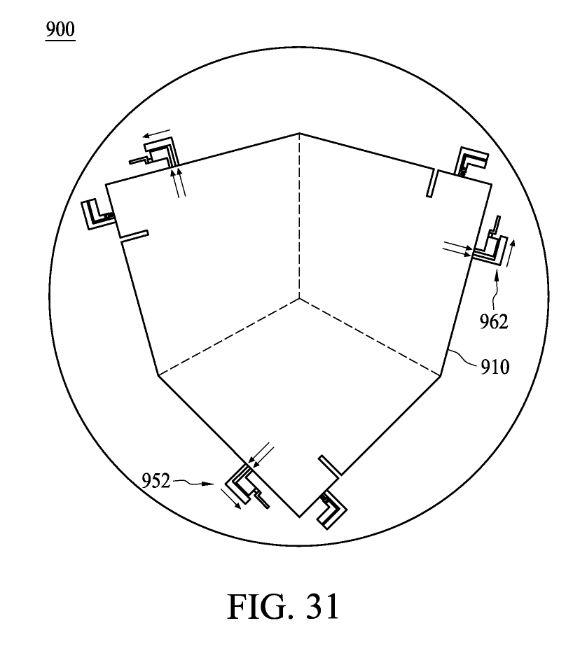

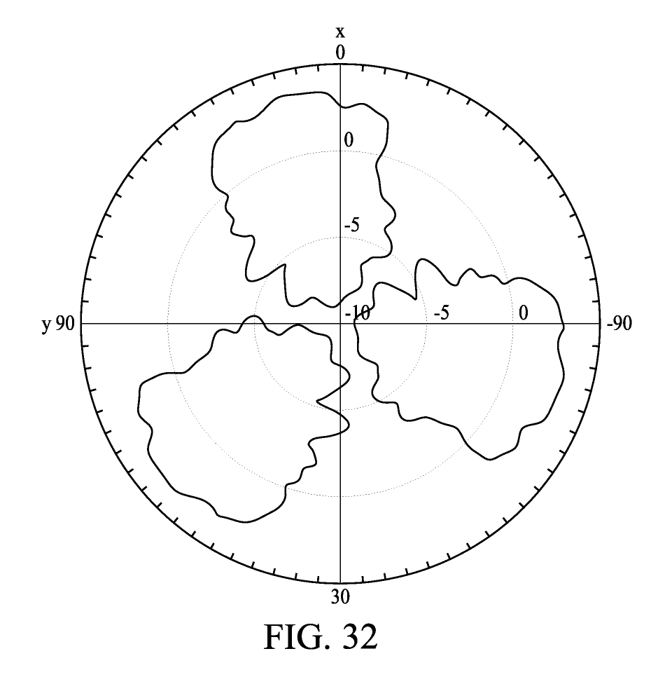

As shown in FIG. 29, in the cut-off mode, when the RF current at the grounded plane 910 is guided into the first RF current dragger 953, the second RF current dragger 963 and the third RF current dragger 923, the antenna structure 900 transmits the second radiation pattern shown in FIG. 30. As shown in FIG. 31, in the guide-in mode, when the RF current (as indicated by the arrow) of the grounded plane 910 is guided into the first RF current dragger 953, the second RF current dragger 963 and the third RF current dragger 923, the antenna structure 900 transmits the first radiation pattern shown in FIG. 32. Furthermore, the antenna structure 900 includes the first radiation area 950, the second radiation area 960 and the third radiation area 920. Since each of the three radiation areas 920, 950, 960 are configured to form two radiation patterns which forms 120° coverage area of the antenna structure 900, the first radiation area 950, the second radiation area 960 and the third radiation area 920 of the antenna structure 900 may transmit 8 radiation patterns so as to form 360° coverage area of the antenna structure 900.

In addition, the antenna structure 900 further includes an inductor (not shown) and a single feeding point (not shown) from the RF signal source 970 located at the first area 911. The inductor of the present embodiment is similar to the inductor 670 shown in FIG. 12 and is configured to prevent the RF signal from interfering the control signal.

Moreover, the single feeding point of the present embodiment is similar to the single feeding point 550 shown in FIG. 9 and is located at the first active antenna 951 adjacent to the first edge 913.

Furthermore, the antenna structure 900 further includes at least one slot 980. The length of the slot 980 is substantially equal to one-quarter wavelength of the operation center frequency of the antenna structure 900. The slot 980 is disposed at a circular area whose center is the location of the single feeding point, while the radius of the circular area ranges from one wavelength of the operation center frequency. Additionally, the slot 980 perturbs the RF currents around the slot so as to adjust a main beam direction of the first radiation pattern or the second radiation pattern.

In another embodiment (not shown), the antenna structure of each area includes the technical features of the foregoing embodiments.

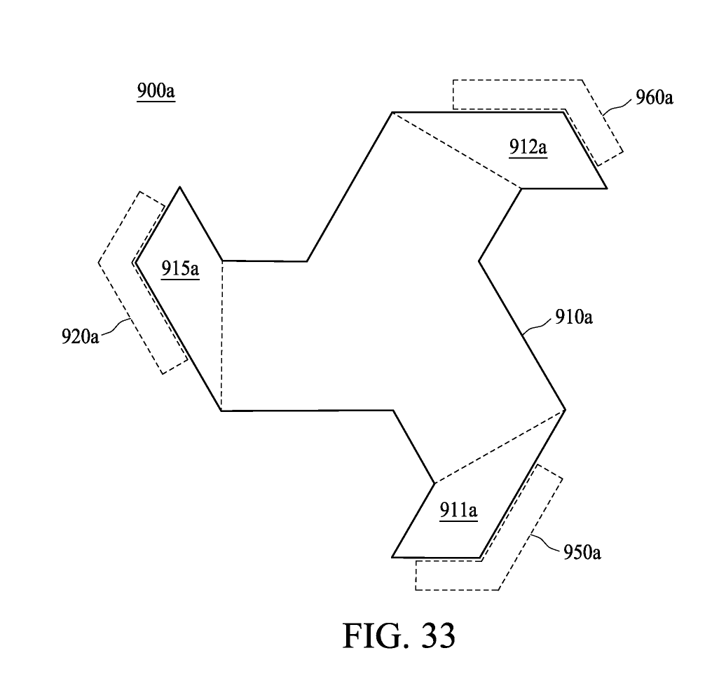

In the embodiment shown in FIG. 33, the grounded plane 910a of the antenna structure 900a can be designed to form a polygon-liked grounded planes selected from the a star-liked grounded plane, a square grounded plane, a rectangular grounded plane, a triangular grounded plane and a rhombus grounded plane. In the embodiment, the first area 911a is not adjacent to the second area 912a. The first radiation area 950a and the second radiation area 960a are similar to the first radiation area 950 and the second radiation area 960 shown in FIG. 29. In another embodiment, the antenna structure 900a further includes a third radiation area 920a located at the dotted line area adjacent to the grounded plane 910a. Thus, the third area 915a is disposed corresponding to the third radiation area 920a.

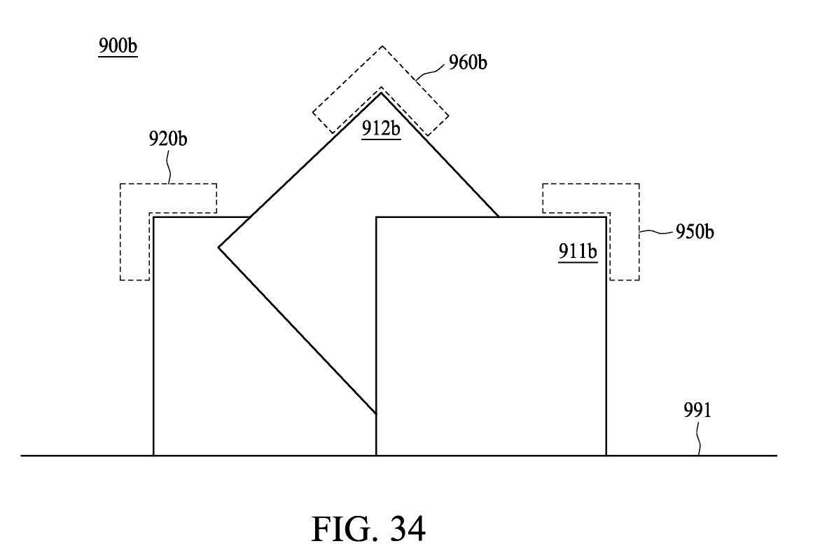

As shown in FIG. 34, the antenna structure 900b of the present disclosure can be disposed on the wall 991. The first area 911b may overlap with the second area 912b so as to allow the radiation pattern formed by RF current distribution resulted from the first radiation area 950b, the second radiation area 960b and the third radiation area 920b to generate a coverage area away from the wall 991.

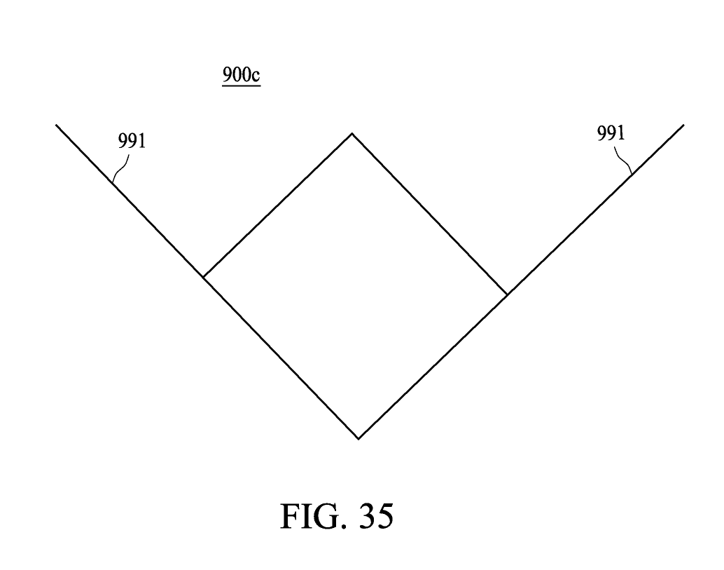

In the embodiment shown in FIG. 35, the antenna structure 900c of the present disclosure is disposed between two walls 991 to allow the radiation pattern formed by RF current distribution resulted from the antenna structure 900c to generate a coverage area between two walls 991.

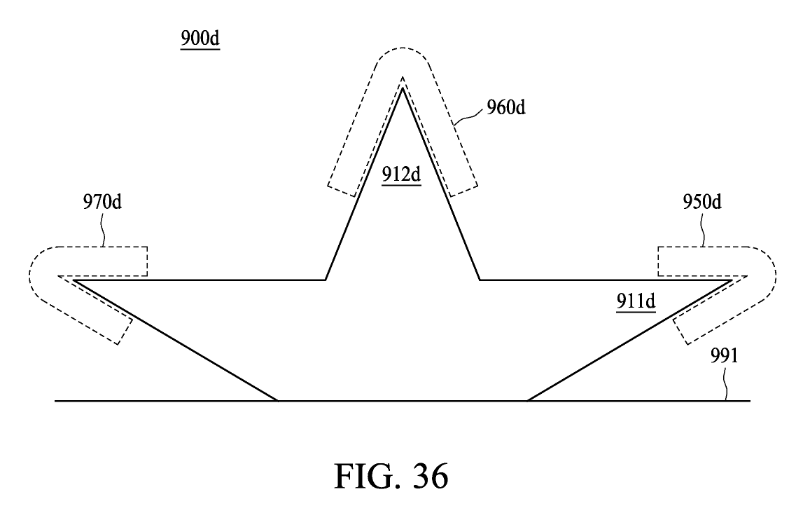

In the embodiment shown in FIG. 36, the angle between the first area 911d and the second area 912d of the antenna structure 900d is smaller than 90°. Although the antenna structure 900d is also disposed on the wall 991, the radiation pattern formed by the RF current distribution resulted from the first radiation area 950d, the second radiation area 960d and the third radiation area 970d to generate a coverage area away from the wall 991.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An antenna structure with a reconfigurable radiation pattern, comprising:
a grounded plane including a first edge and a second edge, wherein the first edge and the second edge form an angle with respect to one another;
at least one active antenna disposed adjacent to the first edge and electrically coupled to a radio frequency (RF) signal source; and
at least one RF current dragger disposed adjacent to the second edge and including at least one switch component, wherein the at least one switch component is configured to adjust a resonance frequency of the at least one RF current dragger so as to either guide an RF current at the grounded plane into the at least one RF current dragger or cut off an RF current at the grounded plane from the at least one RF current dragger.

2. The antenna structure according to claim 1, wherein when the RF current at the grounded plane is guided into the at least one RF current dragger, the antenna structure forms a first radiation pattern, and when the RF current at the grounded plane is cut off from the at least one RF current dragger, the antenna structure forms a second radiation pattern, and the first radiation pattern is distinguishable from the second radiation pattern.

3. The antenna structure according to claim 2, wherein when the RF current at the grounded plane is guided into the at least one RF current dragger, the at least one RF current dragger is resonated within an operation bandwidth of the active antenna so as to switch the second radiation pattern to the first radiation pattern.

4. The antenna structure according to claim 1 further comprising a controller configured to output a control signal, wherein the at least one switch component either guides the RF current at the grounded plane into the at least one RF current dragger or cuts off the RF current at the grounded plane from the at least one RF current dragger in accordance with the control signal.

5. The antenna structure according to claim 1 further comprising a single feeding point of the RF signal source, wherein the single feeding point is disposed at the active antenna and adjacent to the first edge.

6. The antenna structure according to claim 1, wherein the length of the grounded plane ranges from one-quarter to 5 wavelengths of the operation center frequency of the antenna structure.

7. The antenna structure according to claim 1 further comprising a slot, wherein the length of the slot is equal to one-quarter wavelength of the operation center frequency of the antenna structure.

8. The antenna structure according to claim 5 further comprising a slot, wherein the slot is disposed at a circular area, the location of the single feeding point is the center of the circular area, and the radius of the circular area ranges from one-quarter to one wavelength of the operation center frequency of the antenna structure.

9. The antenna structure according to claim 1, wherein the angle is 90°, and the resonant length of the at least one RF current dragger is substantially equal to one-quarter wavelength of the operation center frequency of the antenna structure.

10. The antenna structure according to claim 5, wherein the at least one RF current dragger is disposed at a circular area, the location of the single feeding point is the center of the circular area, and the radius of the circular area ranges from one-quarter to one wavelength of the operation center frequency of the antenna structure.

11. The antenna structure according to claim 2 further comprising a slot, wherein the slot perturbs the RF currents around the slot so as to adjust a main beam direction of the first radiation pattern or the second radiation pattern.

12. An antenna structure with a reconfigurable radiation pattern, comprising:
a grounded plane including a first area and a second area, wherein the first area is adjacent to the second area, and includes a first edge and a second edge, and the first edge and the second edge form an angle with respect to one another;
a first radiation area disposed adjacent to the first area and including:
a first active antenna disposed adjacent to the first edge and electrically coupled to a radio frequency (RF) signal source; and
a first RF current dragger disposed adjacent to the second edge and including a first switch component, wherein the first switch component electrically couples to the first RF current dragger or the grounded plane;
a second radiation area disposed adjacent to the second area and including a second active antenna and a second RF current dragger, wherein the second RF current dragger includes a second switch component;
a first control line electrically connected to the first RF current dragger; and
a second control line electrically connected to the second RF current dragger,
wherein the first control line and the second control line are configured to output a control signal to the first switch component and the second switch component, the first switch component adjusts the resonant frequency of the first RF current dragger in accordance with the output a control signal, the RF current at the grounded plane is either guided into or cut off from the first RF current dragger in response to the resonant frequency of the first RF current dragger, the second switch component adjusts the resonant frequency of the second RF current dragger in accordance with the control signal, and the RF current at the grounded plane is either guided into or cut off from the second RF current dragger in response to the resonant frequency of the second RF current dragger.

13. An antenna structure with a reconfigurable radiation pattern, comprising:
a grounded plane including a first edge and a second edge, wherein the first edge and the second edge form an angle with respect to one another;
at least one active antenna disposed adjacent to the first edge and electrically coupled to a radio frequency (RF) signal source; and
at least one RF current dragger disposed adjacent to the second edge and including at least one switch component, wherein the at least one switch component is disposed between the grounded plane and the at least one RF current dragger and configured to either guide the RF current at the grounded plane into the at least one RF current dragger or cut off the RF current at the grounded plane from the at least one RF current dragger.

14. The antenna structure according to claim 13, wherein when the RF current at the grounded plane is guided into the at least one RF current dragger, the antenna structure forms a first radiation pattern, and when the RF current at the grounded plane is cut off from the at least one RF current dragger, the antenna structure forms a second radiation pattern, and the first radiation pattern is distinguishable from the second radiation pattern.

15. The antenna structure according to claim 14 further comprising a controller configured to output a control signal, wherein the at least one switch component either guides the RF current at the grounded plane into the at least one RF current dragger or cuts off the RF current at the grounded plane from the at least one RF current dragger in response to the output a control signal.

16. The antenna structure according to claim 13 further comprising a single feeding point of the RF signal source, wherein the single feeding point is disposed at the active antenna and adjacent to the first edge.

17. The antenna structure according to claim 13, wherein the length of the grounded plane ranges from one-quarter to 5 wavelengths of the operation center frequency of the antenna structure.

18. The antenna structure according to claim 13 further comprising a slot, wherein the length of the slot is equal to one-quarter wavelength of the operation center frequency of the antenna structure.

19. The antenna structure according to claim 16 further comprising a slot, wherein the slot is disposed at a circular area, the location of the single feeding point is the center of the circular area, and the radius of the circular area ranges from one-quarter to one wavelength of the operation center frequency of the antenna structure.

20. The antenna structure according to claim 13, wherein the angle is 90°, and the resonant length of the at least one RF current dragger is substantially equal to one-quarter wavelength of the operation center frequency of the antenna structure.

21. The antenna structure according to claim 16, wherein the at least one RF current dragger is disposed at a circular area, the location of the single feeding point is the center of the circular area, and the radius of the circular area ranges from one-quarter to one wavelength of the operation center frequency of the antenna structure.

22. The antenna structure according to claim 14 further comprising a slot, wherein the slot perturbs RF currents around the slot so as to adjust a main beam direction of the first radiation pattern or the second radiation pattern.

23. An antenna structure with a reconfigurable radiation pattern, comprising:
a grounded plane including a first area and a second area, wherein the first area is adjacent to the second area and includes a first edge and a second edge, and the first edge and the second edge form an angle with respect to one another;
a first radiation area disposed adjacent to the first area and including:
a first active antenna disposed adjacent to the first edge and electrically coupled to a radio frequency (RF) signal source; and
a first RF current dragger disposed adjacent to the second edge and including a first switch component, wherein the first switch component electrically couples to the first RF current dragger or the grounded plane;
a second radiation area disposed adjacent to the second area and including a second active antenna and a second RF current dragger, wherein the second RF current dragger includes a second switch component;
a first control line electrically connected to the first RF current dragger; and
a second control line electrically connected to the second RF current dragger,
wherein the first control line and the second control line are configured to output a control signal to the first switch component and the second switch component, the first switch component is disposed between the grounded plane and the first RF current dragger, the second switch component is disposed between grounded plane and the second RF current dragger, and the first switch component switches between open-circuit status and short-circuit status between the first RF current dragger and the grounded plane in response to the control signal, wherein during the short-circuit status, the first switch component guides the RF current of the grounded plane into the first RF current dragger, and during the open-circuit status, the first switch component cuts off the RF current at the grounded plane from the first RF current dragger, and the second switch component switches between open-circuit status and short-circuit status between the second RF current dragger and the grounded plane in response to the control signal, wherein during the short-circuit status, the second switch component guides the RF current at the grounded plane into the second RF current dragger, and during the open-circuit status, the second switch component cuts off the RF current at the grounded plane from the second RF current dragger.
